(19) United States
(12) Patent Application Publication
(10) Pub. No.: US 2013/0093734 A1
(43) Pub. Date: Apr. 18, 2013

(54) LIQUID DISPLAY DEVICE AND DRIVING METHOD THEREOF

(71) Applicant: Nianmao Wang, Shenzhen (CN)

(72) Inventor: Nianmao Wang, Shenzhen (CN)

(73) Assignee: SHENZHEN CHINA STAR OPTOELECTRONICS TECHNOLOGY CO. LTD., Shenzhen, Guangdong (CN)

(21) Appl. No.: 13/380,035

(22) PCT Filed: Oct. 24, 2011
(86) PCT No.: PCT/CN2011/081183

§ 371 Date: Dec. 21, 2011

(30) Foreign Application Priority Data
Oct. 14, 2011 (CN) 201110313144.9

(51) Int. Cl. G09G 3/36; G06F 3/038

(52) U.S. Cl. 345/204; 345/87

(57) ABSTRACT

A liquid crystal display includes a liquid crystal panel, 2m scan lines, n/2 data lines, a gate driver for applying scanning signals to the scan lines respectively, and a source driver for applying data signals to the data lines respectively. The scan lines are disposed on the liquid crystal panel and extend along a long-axis direction of substrate respectively. The data lines are disposed on the liquid crystal panel and extend along a short-axis direction of substrate respectively. The scan lines and data lines define a sub-pixels area of n rows*m columns, a scan line 2k−1 and a scan line 2k are alternatively connected to all sub-pixels in a column k, and a data line g electrically connects sub-pixels in columns 2g−1 with sub-pixels in column 2g, wherein 1≦k≦m, 1≦g≦n/2, m, k, n, g are all natural numbers, and n is a multiple of two.

### BACKGROUND

1. Technical Field

The present disclosure relates to the field of liquid crystal display, and particularly to a liquid crystal display and a driving method thereof.

2. Description of Related Art

With the development of liquid crystal displaying technologies, liquid crystal displays are now commonly used in various kinds of electronic devices such as mobile phones, personal digital assistances, digital cameras, and displays of personal computers.

A common liquid crystal display often includes a number of source drivers to control a number of data lines. Since the source drivers are expensive, some manufacturers often reduce the number of the source drivers to be one third or a half of the original number to reduce manufacturing cost of the liquid crystal display. However, in this situation, each data line should insulatingly intersect a large number of scan lines, which may result in the heavy delay of the so called RC (resistance-capacitance) delay circuit. Additionally, the effective charging time of each pixel of the liquid crystal display is shortened correspondingly, thus, the corresponding sub-pixel cannot be charged fully and the display effect of the liquid crystal display may be further influenced.

### SUMMARY

The main purpose of this invention is to provide a liquid crystal display and a method of driving it to reduce the number of source drivers so as to reduce manufacturing cost and make the sub-pixel have enough charging time.

In one embodiment, a liquid crystal display includes a liquid crystal panel with a number of sub-pixels; 2m scan lines, n/2 data lines, a gate driver, and a source driver. The 2m scan lines are disposed on the liquid crystal panel and extending along a long-axis direction of substrate. The n/2 data lines are disposed on the liquid crystal panel and extending along a short-axis direction of substrate. The gate driver is configured for applying a plurality of scanning signals to the scan lines respectively. The source driver is configured for applying a plurality of data signals to the data lines respectively. The 2m scan lines and the n/2 data lines define a sub-pixel area of n rows*m columns, two adjacent scan lines 2k−1 and 2k are alternatively connected to all the sub-pixels in a column k, and a data line Dg of the n/2 data lines is electrically connects the sub-pixels in two adjacent rows 2g−1 and 2g, wherein 1≦k≦m, 1≦g≦n/2, m, k, n, g are all natural numbers, and n is a multiple of two.

Preferably, in the column k, the scan line 2k−1 is electrically connected to sub-pixels located in odd rows, and the scan line 2k is electrically connected to sub-pixels located in even rows.

Preferably, the gate driver applies the scanning signals to the scan lines 2k−1 and 2k at the same time, and the source driver applies the data signals to the sub-pixels in the column k through the data lines.

Preferably, the gate driver stops applying the scanning signals to the scan line 2k−1 after the data signals are written into the corresponding sub-pixels connected to the scan line 2k−1 correctly, and the gate driver stops applying the scanning signals to the scan line 2k after the data signals are written into the corresponding sub-pixels connected to the scan line 2k correctly.

Preferably, the gate driver applies the scanning signals to the scan lines 2k−1 and 2k, and the source driver applies the data signal to the sub-pixels in the column k through the data lines.

Preferably, in the column k, the scan line 2k−1 is electrically connected to the sub-pixels located in even rows, and the scan line 2k is electrically connected to the sub-pixels located in odd rows.

In other embodiments, a method for driving a liquid crystal display includes the following steps: providing a gate driver for applying a number of scanning signals to two adjacent scan lines 2k−1 and 2k at the same time; providing a source driver for applying a number of data signals to all sub-pixels in a column k respectively through a number of data lines; stopping applying the scanning signals to the scan line 2k−1; stopping applying the scanning signals to the scan line 2k; and stopping applying the data signals to the sub-pixels in the column k, wherein k is natural number.

Preferably, the gate driver keeps applying the scanning signals to the scan line 2k−1 in a first time period t1, the gate driver further keeps applying the scanning signals to the scan line 2k in a second time period t2, and 1/2≦t1/t2<1.

Preferably, 2/3<t1/t2<1.

Preferably, in the column k, the scan line 2k−1 is electrically connected to the sub-pixels located in odd rows, and the scan line 2k is electrically connected to the sub-pixels located in even rows.

Preferably, in the column k, the scan line 2k−1 is electrically connected to the sub-pixels located in even rows, and the scan line 2k is electrically connected to the sub-pixels located in odd rows.

In the present disclosure, every two adjacent scan lines control the sub-pixels in one column, and each data lines controls the sub-pixels in two rows, which reduce the number of the gate drivers and further reduce the manufacturing cost of the liquid crystal display. Additionally, since the gate driver applies the scanning signals to two scan lines electrically connected to the sub-pixels in the same column, and the gate drivers keeps applying the scanning signals to the other scan line of every two adjacent scan lines when one scan line thereof until the sub-pixels corresponding to the scan line are fully charged, therefore, all the sub-pixels can be charged fully and correctly.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view of a liquid crystal display in accordance with an embodiment of the present disclosure.

FIG. 2 is a schematic view of a sub-pixels area of the liquid crystal display of FIG. 1 according to a first exemplary embodiment.

FIG. 3 is a schematic view showing a waveform of a number of scanning signals used for driving the sub-pixels of FIG. 2.

FIG. 4 is a schematic view showing timing sequences of a number of scanning signals applied to the sub-pixels in a first column of the sub-pixels area of FIG. 2.

FIG. 5 is a schematic view showing a sub-pixels area of the liquid crystal display of FIG. 1 according to a second exemplary embodiment.

FIG. 6 is a flow chart of a driving method for driving the liquid crystal display of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

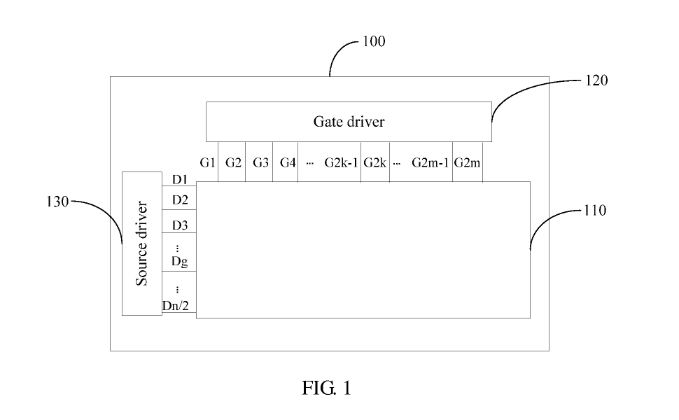

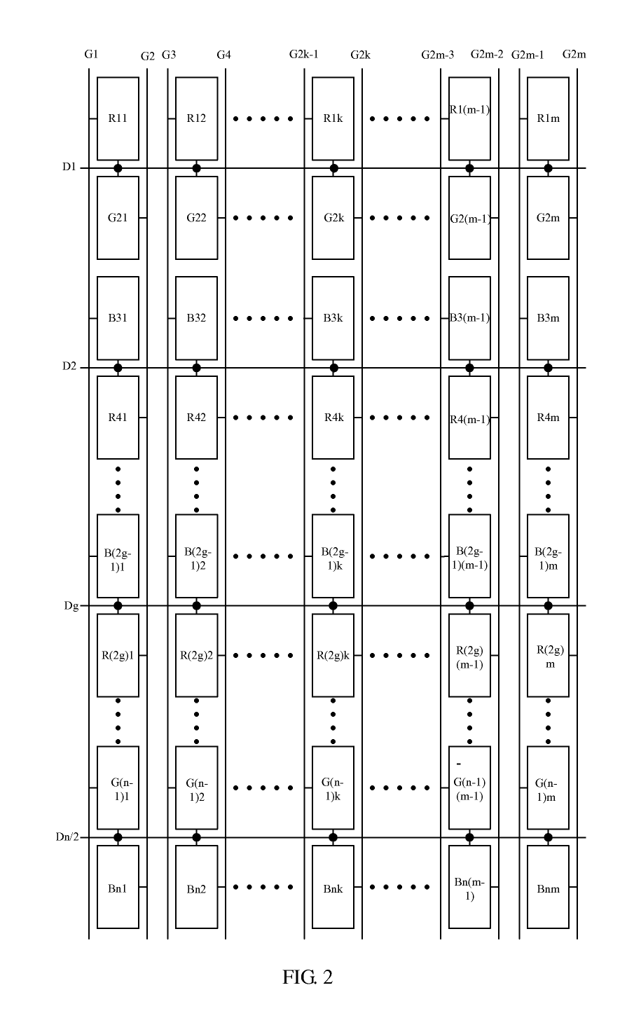

Referring to FIGS. 1 and 2, a liquid crystal display 100 includes a liquid crystal panel 110 with a number of sub-pixels, a number of gate drivers 120, and a number of source drivers 130. A number of scan lines G1, G2, G3 . . . G2k−1, G2k . . . G2m−1, and G2m (wherein 1≦k≦m, k and m are natural numbers) respectively extending horizontally and a number of data lines D1, D2, D3 . . . Dg . . . , and Dn/2 (wherein 1≦g≦n/2, g and n are natural numbers, and n is a multiple of two) respectively extending vertically are disposed in the liquid crystal panel 110. The gate driver 120 is configured for applying scanning signals to the scan lines G1˜G2m. The source driver 130 is configured for applying data signals to the data lines D1˜Dn/2.

As shown in FIG. 2, the scan lines G1˜G2m and the data lines D1˜Dn/2 define a sub-pixels area of n rows*m columns. The sub-pixels in each column include a red sub-pixel R, a green sub-pixel G, and a blue sub-pixels B repeatedly arranged in order. For example, the sub-pixels in the first column include a red sub-pixel R11, a green sub-pixel G21, and a blue sub-pixel B31. In this situation, the sub-pixels in the first column includes R11, G21 . . . B(2g−1)1 . . . G(n−1)1, and Bn1 which are arranged in order. In the embodiment, the first number following R, G, or B refers to the serial number of the row where the corresponding sub-pixel is located, and the second number following R, G, or B refers to the serial number of the column where the corresponding sub-pixel is located.

The sub-pixels located in the same row are the same kind of sub-pixels. For example, the sub-pixels in the first row are all the red sub-pixels R11, R12 . . . R1k . . . R1(m−1), and Rim, the sub-pixels in the second row are all the green sub-pixels G21, G22 . . . G2k, G2(m−1), and G2m, the sub-pixels in the third row are all the blue sub-pixels B31, B32 . . . B3k . . . B3(m−1), and B3m, and the sub-pixels in the forth row are all the red sub-pixels R41, R42, . . . R4k . . . R4(m−1), and R4m. Similarly, the sub-pixels in the row 2g−1 are all the blue sub-pixels B(2g−1)1˜B(2g−1)m, the sub-pixels in the row 2g are all the red sub-pixels R(2g)1˜R(2g)m, the sub-pixels in the row n−1 are all the green sub-pixels G(n−1)1˜G(n−1)m, and the sub-pixels in the row n are all the blue sub-pixels Bn1˜Bnm.

Every two adjacent scan lines are alternatively connected to the sub-pixels in the same column. For example, the scan line G1 and the scan line G2 are alternatively connected to the sub-pixels R11, G21, B31, R41 . . . B(2g−1)1, R(2g)1 . . . G(n−1)1, and Bn1 in the first column; the scan line G3 and the scan line G4 are alternatively connected to the sub-pixels R12, G22 . . . B(2g−1)2, R(2g)2 . . . G(n−1)2, Bn2 in the second column. Similarly, the scan line G2k−1 and the scan line G2k are alternatively connected to the sub-pixels R1k, G2k . . . B(2g−1)k, R(2g)k . . . G(n−1)k, Bnk in column k, and the scan lines 2m−1 and 2m are alternatively connected to the sub-pixels R1m, G2m . . . G(n−1)m, Bnm in the column m.

Referring to FIG. 2, specifically, a first one of every two adjacent scan lines connects all the sub-pixels in odd rows, and a second of every two adjacent scan lines connects all the sub-pixels in even rows. For example, in the first column, the scan line G1 connects all the sub-pixels in odd rows such as R11, B31, and B(2g−1)1, and the scan line G2 connects all the sub-pixels located in even row of the first row such as G21, R41, and R(2g)1. Similarly, in the column k, the scan line 2k−1 electrically connects all the sub-pixels located in odd rows such as R1k, B(2g−1)k, G(n−1)k, and the scan line 2k electrically connects all the sub-pixels in even rows such as G2k, R(2g)k, Bnk. In the embodiment, the gate driver 120 at the same time applies scanning signals to the scan lines G2k−1 and G2k. The source driver 130 outputs a number of parallel data signals to the sub-pixels in column k via data lines D1˜Dn/2.

Each data line connects the sub-pixels in two adjacent rows. For example, the data line D1 connects all the sub-pixels R11˜R1m in the first row with all the sub-pixels G21˜G2m in the second row, and the data line D2 connects all the sub-pixels B31˜B3m in the third row with all the sub-pixels R41˜R4m in the forth row. Similarly, the data line Dg connects all the sub-pixels B(2g−1)1˜B(2g−1)m in the row 2g−1 with all the sub-pixels R(2g)1˜R(2g)m in the row 2g, and the data line n/2 connects all the sub-pixels G(n−1)1˜G(n−1)m in the row n−1 with all the sub-pixels Bn1˜Bnm in the row n.

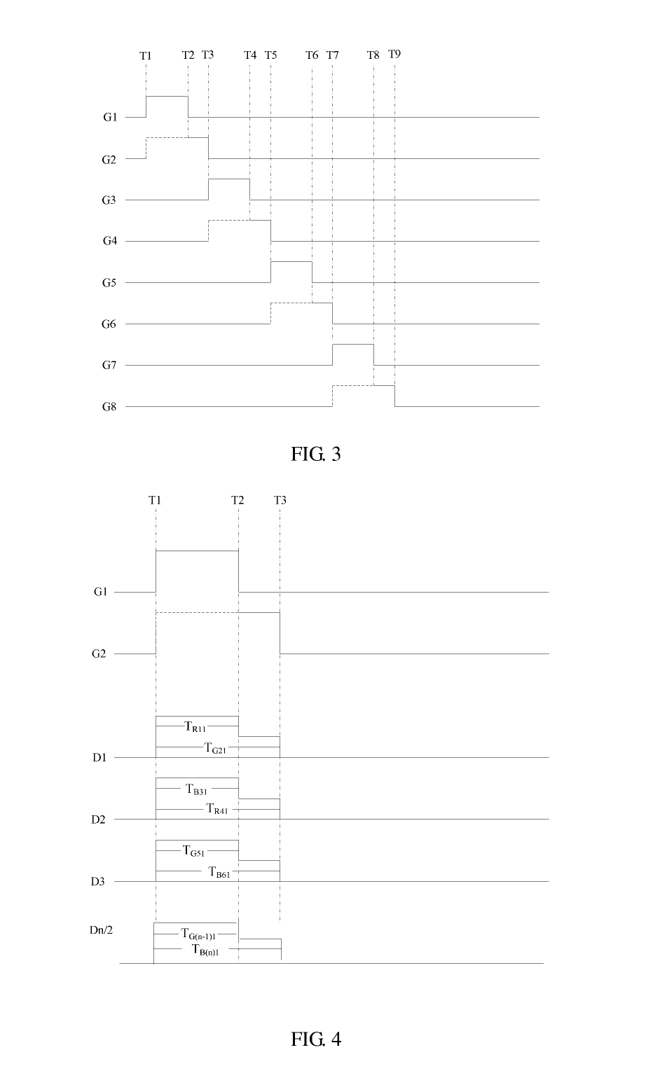

Referring to FIG. 3, the gate driver 120 begins to apply the scanning signals to the scan lines G1, G2 at time point T1 and stops applying the scanning signals to the scan line G1 at time point T2. The gate driver 120 further stops applying the scanning signals to the scan line G2 and begins to apply the scanning signals to the scan lines G3, G4 at time point T3. The gate driver 120 stops applying the scanning signals to the scan line G3 at point T4, and further stops applying the scanning signals to the scan line G4 and begins to apply the scanning signals to the scan lines G5, G6 at point T5. The gate driver 120 stops applying the scanning signals to the scan line G5 at time point T6, and further stops applying the scanning signals to the scan line G6 and begins to apply the scanning signals to the scan lines G7, G8 at time point T7. The gate driver 120 stops applying the scanning signals to the scan line G7 at time point T8 and further stops applying the scanning signals to the scan line G8 at time point T9. The relationship between T1˜T8 can be described as the following mathematical statement:

T2−T1=T4−T3=T6−T5=T8−T7=t1;T3−T1=T5−T3=T7−T5=T9−T7=t2.

Referring to FIG. 4, at time point T1, the source driver 130 begins to apply a number of data signals to the sub-pixels in the first column respectively through the data lines D1˜Dn/2. At time point T2, the corresponding data signals have been written into the sub-pixels in the odd rows such as the sub-pixels R11, B31, G51, G(n−1)1 in the first column correctly to allow the gate driver 120 to stop applying the scanning signals to the scan line G1. At time point T3, the corresponding data signals have been written into the sub-pixels located in the even rows such as the sub-pixels G21, R41, B61, G(n)k in the first column correctly to allow the gate driver 120 to stop applying the scanning signal to the scan line G2. From this, the following conclusion can be drawn: T2−T1=T_{R11}=T_{B31}=T_{G51}=t1; T3−T1=T_{G21}=T_{R41}=T_{B61}=t2. In the conclusion, T_{R11} refers to the time duration in which the data signal is written into the sub-pixel R11, that is, T_{R11} refers to the data charging period of the sub-pixel R11, and T_{G21} refers to the time duration in which the data signal is written into the sub-pixel G21, that is, T_{G21} refers to the data charging period of the sub-pixel G21. Similarly, T_{B31} refers to the time duration in which the data signal is written into the sub-pixel B31 and also to the data charging period of the sub-pixel B31, T_{R41} refers to the time duration in which the data signal is written into the sub-pixel R41 and also to the data charging period of the sub-pixel R41, T_{G51} refers to the time duration in which the data signal is written into the sub-pixel G51 and also to the data charging period of the sub-pixel G51, and T_{B61} refers to the time duration in which the data signal is written into the sub-pixel B61 and also to the data charging period of the sub-pixel B61.

Additionally, the gate driver 120 applies the scanning signals to every two adjacent scan lines at the same time to allow the scanning signals to be transmitted to the sub-pixels connected to the two adjacent scan lines at the same time. The gate driver 120 stops applying the scanning signals to one of the two adjacent scan lines when all the sub-pixels connected to the corresponding scan line are charged enough, and keeps applying the scanning signals to the other one of the two adjacent scan lines until all the sub-pixels connected to the other scan line are charged enough. For example, in the column k, since the scan line G2k−1 is electrically connected to all the sub-pixels located in odd rows and the scan line G2k is electrically connected to all the sub-pixels located in even rows, the gate driver 120 is capable of applying the scanning signals to the scan lines 2k−1, 2k at the same time. At this time, the source driver 130 outputs a number of data signals to the scan lines D1˜Dn/2 respectively and writes the data signals to all the sub-pixels in the column k. The gate driver 120 keeps applying the scanning signals to the scan line G2k−1 in a time period t1 and stops applying the scanning signals to the scan line G2k−1 when the corresponding data signals have been written into the sub-pixels located in odd rows. After stopping applying the scanning signals to the scan line G2k−1, the gate driver 120 keeps applying the scanning signals to the scan line G2k in a time period t2 and stops applying the scanning signals to the scan line G2k when the corresponding data signals have been written into the sub-pixels located in even rows (wherein 1/2≦t1/t2 <1, 1≦k≦m, and both k and m are natural numbers). Preferably, the relationship between t1 and t2 is: 2/3≦t1/t2<1.

In the liquid crystal display 100, the 2m scan lines are often disposed along the a long-axis direction of substrate and the n/2 of data lines are disposed along a short-axis direction of substrate. Each scan line is orthogonal to each data line for reducing the number of the source drivers 130 and further reducing the manufacturing cost the liquid crystal display 100. Meanwhile, since the gate driver 120 is capable of applying the scanning signals to the two adjacent scan lines electrically connected to the sub-pixels in a corresponding column at the same time, and is capable of keeping applying the scanning signals to the other one of the two adjacent scan lines even when the sub-pixels connected to one scan line are enough charged, which guarantees that all the sub-pixels can be fully charged.

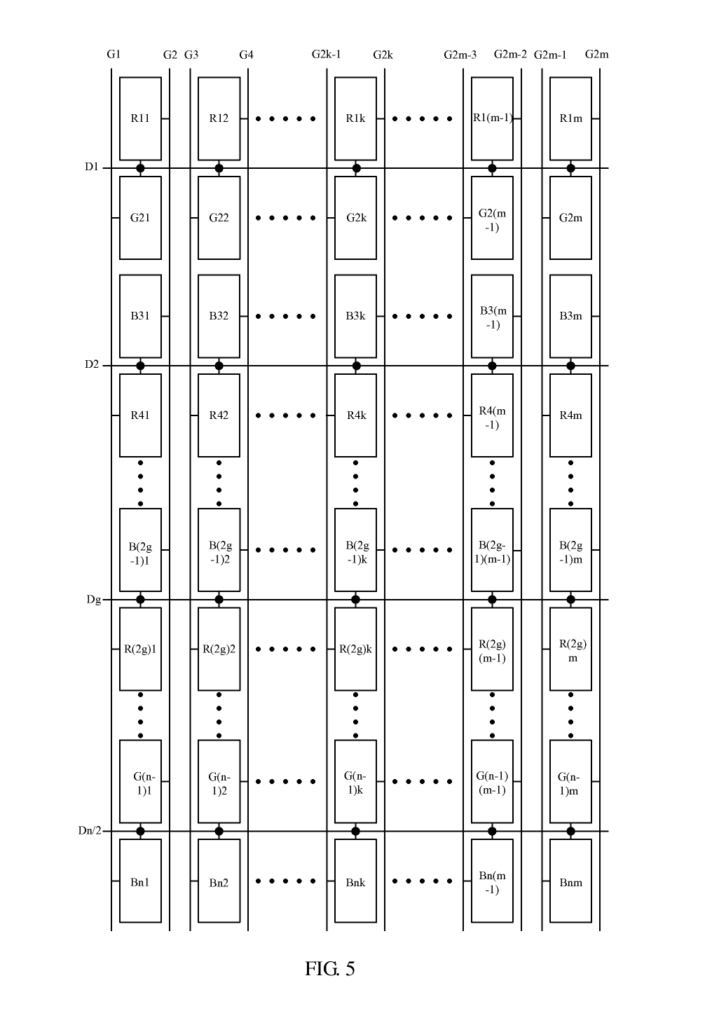

Referring to FIG. 5, in a second embodiment, the first scan line G1 is electrically connected to the sub-pixels located in even rows such as the sub-pixels G21, R41, and R(2g)1 in the first column, and the second scan line G2 is electrically connected to the sub-pixels located in odd rows such as the sub-pixels R11, B31, and B(2g−1)1 in the first column. Similarly, the scan line G2k−1 is electrically connected to the sub-pixels located in even rows such as G2k . . . R(2g)k . . . Bnk in the column k, the scan line G2k is electrically connected to the sub-pixels located in odd rows such as R1k . . . B(2g−1)k . . . G(n−1)k in the column k, the scan line G2m−1 is electrically connected to the sub-pixels located in even rows such as G2m . . . R(2g)m . . . Bnm in the column m, and the scan line G2m is electrically connected to the sub-pixels located in odd rows such as R1m . . . B(2g−1)m . . . G(n−1)m in the column m. For example, the gate driver 120 applies scanning signals to the scan lines G2k−1, G2k at the same time. The source driver 130 outputs a number of data signals to the sub-pixels in the column k respectively through the data lines D1˜Dn/2. The gate driver 120 stops applying the scanning signals to the scan line G2k−1 after the corresponding data signals have been written into the sub-pixels corresponding the scan line G2k−1 correctly. The gate driver 120 stops applying the scanning signals to the scan line G2k after the corresponding data signals have been written into the sub-pixels corresponding the scan line G2k correctly.

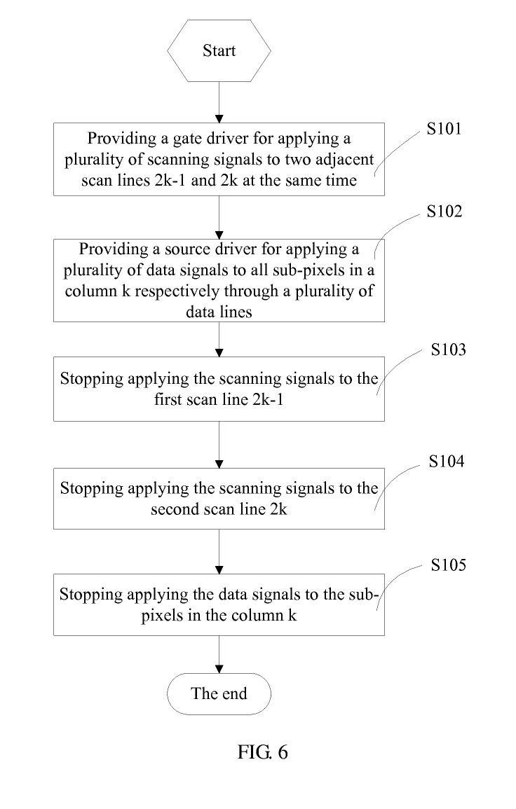

Referring to FIG. 6, a driving method for driving the liquid crystal display 100 is provided. The driving method includes the following steps:

In step S101, providing a gate driver for applying a number of scanning signals to two adjacent scan lines 2k−1 and 2k at the same time.

In step S102, providing a source driver for applying a number of data signals to sub-pixels in a column k respectively through a data line.

In step S103, stopping applying the scanning signals to the scan line 2k−1.

In step S104, stopping applying the scanning signals to the scan line 2k.

In step S105, the source driver stops applying the data signals to the sub-pixels in the column k.

In an embodiment, in the column k, the scan line G2k−1 is electrically connected to the sub-pixels located in odd rows and the scan line G2k is electrically connected to the sub-pixels located in even rows.

In another embodiment, in the column k, the scan line G2k−1 is electrically connected to the sub-pixels located in even rows, and the scan line G2k is electrically connected to the sub-pixels located in odd rows.

In another embodiment, the gate driver keeps applying the scanning signals to the scan line G2k−1 in a time period t1 and keeps applying the scanning signals to the scan line G2k in a time period t2, wherein 1/2≦t1/t2<1. Preferably, the relationship between t1 and t2 is: 2/3≦t1/t2<1.

In the driving method, the gate driver is capable of applying the scanning signals to the two adjacent scan lines electrically connected to the same column at the same time, and is capable of stopping applying the scanning signals to one of the two adjacent scan lines when the sub-pixels connected to the corresponding scan line are fully charged, and further is capable of keeping applying the scanning signals to the other scan line of the two adjacent scan lines until the sub-pixels connected to the other scan line are fully charged. Therefore, the sub-pixels can be fully charged for sufficient charging time to improve the display effect and the driving speed of the liquid crystal display 100.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A liquid crystal display, comprising:
a liquid crystal panel with a plurality of sub-pixels;
2m scan lines disposed on the liquid crystal panel and extending along a long-axis direction of substrate;
n/2 data lines disposed on the liquid crystal panel and extending along a short-axis direction of substrate;
a gate driver for applying a plurality of scanning signals to the scan lines respectively;
a source driver for applying a plurality of data signals to the data lines respectively;
wherein the 2m scan lines and the n/2 data lines define a sub-pixels area of n rows*m columns, two adjacent scan lines 2k−1 and 2k are alternatively connected to all sub-pixels in a column k, and a data line g of the n/2 data lines is electrically connected the sub-pixels in two adjacent rows 2g−1 and 2g, wherein 1≦k≦m, 1≦g≦n/2, m, k, n, g are all natural numbers, and n is a multiple of two.

2. The liquid crystal display as claimed in claim 1, wherein in the column k, the scan line 2k−1 is electrically connected to sub-pixels located in odd rows and the scan line 2k is electrically connected to sub-pixels located in even rows.

3. The liquid crystal display as claimed in claim 2, wherein the gate driver applies the scanning signals to the two adjacent scan lines 2k−1 and 2k at the same time, and the source driver applies the data signals to the sub-pixels in the column k through the data lines.

4. The liquid crystal display as claimed in claim 3, wherein the gate driver stops applying the scanning signals to the scan line 2k−1 after the data signals are written into the corresponding sub-pixels connected to the scan line 2k−1 correctly, and the gate driver stops applying the scanning signals to the scan line 2k after the data signals are written into the corresponding sub-pixels connected to the scan line 2k correctly.

5. The liquid crystal display as claimed in claim 1, wherein in the column k, the scan line 2k−1 is electrically connected to the sub-pixels located in even rows, and the scan line 2k is electrically connected to the sub-pixels located in odd rows.

6. The liquid crystal display as claimed in claim 5, wherein the gate driver applies the scanning signals to the two adjacent scan lines 2k−1 and 2k, and the source driver applies the data signal to the sub-pixels in the column k respectively through the data lines.

7. The liquid crystal display as claimed in claim 6, wherein the gate driver stops applying the scanning signals to the scan line 2k−1 after the data signals are written into the corresponding sub-pixels connected to the scan line 2k−1 correctly, and the gate driver further stops applying the scanning signals to the scan line 2k after the scanning signals are written into the corresponding sub-pixels connected to the scan line 2k correctly.

8. A driving method for driving a liquid crystal display, comprising the following steps:
providing a gate driver for applying a plurality of scanning signals to two adjacent scan lines 2k−1 and 2k at the same time;
providing a source driver for applying a plurality of data signals to all sub-pixels in a column k respectively through a plurality of data lines;
stopping applying the scanning signals to the scan line 2k−1;
stopping applying the scanning signals to the scan line 2k;
stopping applying the data signals to the sub-pixels in a column k, wherein k is natural number.

9. The driving method as claimed in claim 8, wherein the gate driver keeps applying the scanning signals to the scan line 2k−1 in a first time period t1, the gate driver further keeps applying the scanning signals to the scan line 2k in a second time period t2, and 1/2≦t1/t2<1.

10. The driving method as claimed in claim 9, wherein 2/3≦t1/t2<1.

11. The driving method as claimed in claim 8, wherein in the column k, the scan line 2k−1 is electrically connected to the sub-pixels located in odd rows, and the scan line 2k is electrically connected to the sub-pixels located in even rows.

12. The driving method as claimed in claim 11, wherein the gate driver keeps applying the scanning signals to the scan line 2k−1 in a first time period t1, the gate driver further keeps applying the scanning signals to the scan line 2k in a second time period t2, and 1/2≦t1/t2<1.

13. The driving method as claimed in claim 12, wherein 2/3≦t1/t2<1.

14. The driving method as claimed in claim 8, wherein in the column k, the scan line 2k−1 is electrically connected to the sub-pixels located in even rows, and the scan line 2k is electrically connected to the sub-pixels located in odd rows.

15. The driving method as claimed in claim 14, wherein the gate driver keeps applying the scanning signals to the scan line 2k−1 in a first time period t1, the gate driver further keeps applying the scanning signals to the scan line 2k in a second time period t2, and 1/2≦t1/t2<1.

16. The driving method as claimed in claim 15, wherein 2/3≦t1/t2<1.
